(19) United States
(12) Patent Application Publication
(10) Pub. No.: US 2007/0236594 A1
(43) Pub. Date: Oct. 11, 2007

(54) Techniques for radial fall-off correction

(76) Inventors: Zafar Hasan, Portland, OR (US); Moinul H. Khan, Austin, TX (US); Tung Nguyen, Jacksonville, FL (US)

Correspondence Address: KACVINSKY LLC;C/O INTELLEVATE, P.O. BOX 52050, MINNEAPOLIS, MN, 55402, US

(21) Appl. No.: 11/394,405

(22) Filed: Mar. 31, 2006

(51) Int. Cl. G02B 13/16

(52) U.S. Cl. 348/335

(57) ABSTRACT

A system, apparatus, method and article to perform radial fall-off correction are described. The apparatus may include a coefficient determination module and a fall-off correction module. The coefficient determination module determines a fall-off correction coefficient for a pixel of an image sensor, and the fall-off correction module corrects the pixel based on an intensity value of the pixel and the fall-off correction coefficient. The fall-off correction coefficient may be based on one or more stored coefficient values, where the one or more coefficient values correspond to a squared distance between the pixel and a center position of the image sensor. In this manner, improvements in computational efficiency and reductions in implementation complexity are attained. Other embodiments may be described and claimed.

### BACKGROUND

Most lenses are brighter in the center than at the edges. This phenomenon is known as light fall-off or vignetting. Light fall-off is especially pronounced with wide-angle lenses, certain long telephoto lenses, and many lower quality lenses. These lower quality lenses are often used in devices, such as mobile phones, because the employment of higher quality lenses would increase the costs of such devices to levels that are not commercially feasible.

Light fall-off can be mitigated through compensation techniques. Accordingly, effective fall-off compensation techniques are needed. Moreover, such techniques are needed that do not substantially increase device costs, device power consumption, or device complexity.

### BRIEF DESCRIPTION OF THE DRAWINGS

FIG. 1 is a diagram showing an embodiment of an apparatus.

FIG. 2 is a diagram illustrating an exemplary geometric relationship.

FIG. 3 is a graph of an exemplary correction coefficient curve.

FIGS. 4, 5A, and 5B are graphs showing exemplary interpolation approaches.

FIG. 6 is a diagram showing an implementation embodiment that may be included within an encoding module.

FIGS. 7A and 7B are diagrams illustrating embodiments of coefficient determination implementations

FIG. 8 illustrates one embodiment of a logic diagram.

FIG. 9 illustrates one embodiment of a system.

### DETAILED DESCRIPTION

Various embodiments may be generally directed to fall-off compensation techniques. For example, in one embodiment, a coefficient determination module determines a fall-off correction coefficient for a pixel of an image sensor, and a fall-off correction module corrects the pixel based on an intensity value of the pixel and the fall-off correction coefficient. The fall-off correction coefficient may be based on one or more stored coefficient values, where the one or more coefficient values correspond to a squared distance between the pixel and a center position of the image sensor. In this manner, improvements in computational efficiency may be achieved. Also, reductions in power consumption, implementation complexity, and area may be attained. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

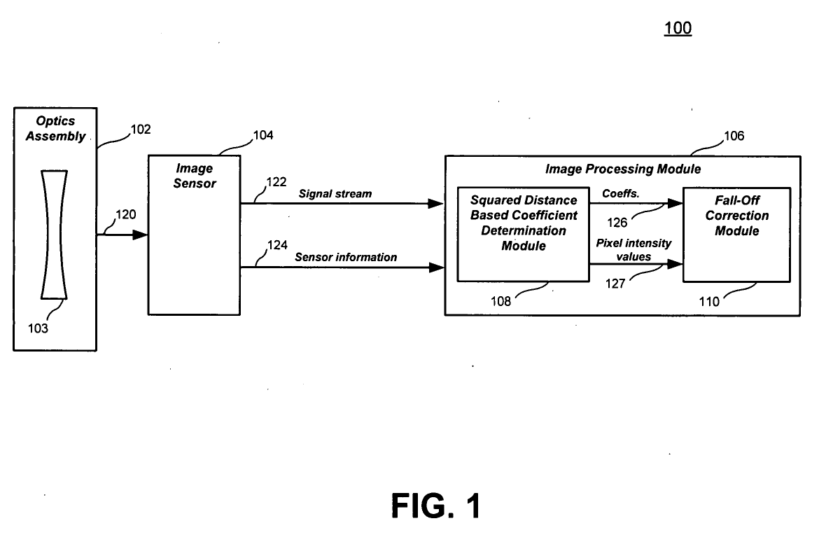

FIG. 1 illustrates one embodiment of an apparatus. In particular, FIG. 1 shows an apparatus 100 including various elements. However, the embodiments are not limited to these elements. For instance, embodiments may include greater or fewer elements, as well as other couplings between elements.

In particular, FIG. 1 shows that apparatus 100 may include an optics assembly 102, an image sensor 104, and an image processing module 106. These elements may be implemented in hardware, software, or in any combination thereof. For instance, one or more elements (such as image sensor 104 and image processing module 106) may be implemented on a same integrated circuit or chip. However, the embodiments are not limited in this context.

Optics assembly 102 may include one or more optical devices (e.g., lenses, mirrors, etc.) to project an image within a field of view onto multiple sensor elements within image sensor 104. For instance, FIG. 1 shows optical assembly having a lens 103. In addition, optics assembly 102 may include mechanism(s) to control the arrangement of these optical device(s). For instance, such mechanisms may control focusing operations, aperture settings, zooming operations, shutter speed, effective focal length, etc. The embodiments, however, are not limited to these examples.

Image sensor 104 may include an array of sensor elements (not shown). These elements may be complementary metal oxide semiconductor (CMOS) sensors, charge coupled devices (CCDs), or other suitable sensor element types. These elements may generate analog intensity signals (e.g., voltages), which correspond to light incident upon the sensor. In addition, image sensor 104 may also include analog-to-digital converter(s) ADC(s) that convert the analog intensity signals into digitally encoded intensity values. The embodiments, however, are not limited to this example.

Thus, image sensor 104 converts light received through optics assembly 102 into pixel values. Each of these pixel values represents a particular light intensity at the corresponding sensor element. Although these pixel values have been described as digital, they may alternatively be analog.

Image sensor 104 may have various adjustable settings. For instance, its sensor elements may have one or more gain settings that quantitatively control the conversion of light into electrical signals. In addition, ADCs of image sensor 104 may have one or more integration times, which control the duration in which sensor element output signals are accumulated. Such settings may be adapted based on environmental factors, such as ambient lighting, etc. Together, optics assembly 102 and image sensor 104 may further have one or more settings. One such setting is a distance between one or more lenses of optics assembly 102 and a sensor plane of image sensor 104. Effective focal length is an example of such a distance.

FIG. 1 shows that the pixel values generated by image sensor 104 may be arranged into a signal stream 122, which represents one or more images. Thus, signal stream 122 may comprise a sequence of frames or fields having multiple pixel values. Each frame/field (also referred to as an image signal) may correspond to a particular time or time interval. In embodiments, signal stream 122 is digital. Alternatively, signal stream 122 may be analog.

In addition, FIG. 1 shows that image sensor 104 may provide image processing module 106 with sensor information 124. This information may include operational state information associated with image sensor 104, as well as one or more of its settings. Examples of sensor settings include effective focal length, sensor element gain(s) and ADC integration time(s). Signal stream 122 and sensor information 124 may be transferred to image processing module 106 across various interfaces. One such interface is a bus.

FIG. 1 shows that image processing module 106 may include a squared distance based coefficient determination module 108 (also referred to as coefficient determination module 108) and a fall-off correction module 110.

Coefficient determination module 108 determines fall-off coefficients for pixels within image sensor 104. In particular, coefficient determination module 108 may determine fall-off coefficients based on squared distances and one or more stored coefficient values. These stored values may be arranged in various ways such as in one or more look-up tables (LUTs). Such LUT(s) may store multiple coefficient values, each having an address based on a squared distance from a center position of image sensor 104. Moreover, these squared distances may be separated by substantially equal intervals.

To reduce storage requirements and/or hardware complexity, such LUT(s) may have fewer than the number of entries to cover every possible squared distance associated with image sensor 104. Accordingly, for a particular pixel, coefficient determination module 108 may access two LUT entries corresponding to a closest higher squared distance and a closest lower squared distance. From these two entries, coefficient determination module 108 may employ various interpolation techniques to produce a correction coefficient for the particular pixel.

In addition, coefficient determination module 108 may scale correction coefficients based on various settings. One such setting is the distance (e.g., effective focal length) associated with optical assembly 102 and image sensor 104.

As shown in FIG. 1, fall-off correction module 110 may receive correction coefficients 126 from coefficient determination module 108, in which each coefficient corresponds to a particular pixel. From these coefficients, correction module 110 corrects pixels based on their corresponding pixel intensity values 127 and their fall-off correction coefficients. For example, this may comprise multiplying a pixel intensity value received from image sensor 104 (e.g., in signal stream 122) with its corresponding correction coefficient.

Accordingly, modules 108 and 110 may provide for effective fall-off correction. For instance, by basing coefficient determination on squared distances and stored coefficient values as described herein, computational efficiencies may be increased while implementation complexities may be decreased.

Apparatus 100 may be implemented in various devices, such as a handheld apparatus or an embedded system. Examples of such devices include mobile wireless phones, Voice Over IP (VoiP) phones, personal computers (PCs), personal digital assistants (PDAs), and digital cameras. In addition, this apparatus may also be implemented in land line based video phones employing standard public switched telephone network (PSTN) phone lines, integrated digital services network (ISDN) phone lines, and/or packet networks (e.g., local area networks (LANs), the Internet, etc.).

The description now turns to a quantitative discussion of fall-off correction features. As described above, light-fall off is an occurrence in which lenses are brighter at their center than at their edges. Light fall-off may be compensated with a gain factor having an inverse relationship to the fall-off amount. The fall-off ratios (relative to the maximum measured value from each respective color or image plane) of the measured median pixel values in each color plane. Equation (1), below, expresses the fall off ratio of each sampling point (i, j) in a color plane c as x_{c}(i,j).
x_{c}(i, j)=Q_{c}(i, j)/Q_{c}^{max} (1)

In Equation (1), Q_{c}(i,j) is the median pixel value measured at sampling point (i, j) of color plane c and Q_{c}^{max} is the maximum median pixel value measured in the same color or image plane.

The compensation factor for each pixel may be computed by using the corresponding fall-off ratio obtained above. Equation (2), below, expresses a fall-off compensation factor, S_{c}(i,j), at a sampling point, (i, j).

$${S}_{c} ( i , j ) = \frac{1}{[ {x}_{c} ( i , j ) + w * ( 1 - {x}_{c} ( i , j ) ) ]} \qquad ( 2 )$$

In Equation (2), w is a shaping factor that controls the extent of falloff compensation and avoids over boosting the image noise while approaching the image boundary.

In addition to being expressed with respect to sampling points, fall-off ratios may be expressed with respect to a color or image plane. More particularly, fall-off ratio may be expressed as a function of the radial distance from the center of a lens. Radial distance from the lens' center to a sampling point at pixel (i,j) may be calculated from a location (i_{c}, j_{c}), which is the location of the pixel at the center of the sensor array. This calculation is expressed below in Equation (3).
r(i, j)=\sqrt{(i−i_{c})²+(j−j_{c})²} (3)

Correction coefficient curves often follow the form of cos⁴θ, in which θ is an angle formed by a line joining a point on the sensor array and the lens center intersecting with the lens' optical axis. A relationship exists between r and θ. This relationship may be expressed for a range of r from zero to D/2, where D is the diagonal length of the sensor. Equation (4), below, provides the relationship of θ to r.

$$θ = arctan ( \frac{2 r tan ( {θ}_{v} / 2 )}{D} ) \qquad ( 4 )$$

In Equation (4), θᵥ represents the angle of view for the image sensor and lens arrangement. An exemplary value of θᵥ is 60 degrees. However, other values may be employed. For a range of θ from about −45 degrees to about 45 degrees, there is an approximately linear mapping between θ and r.

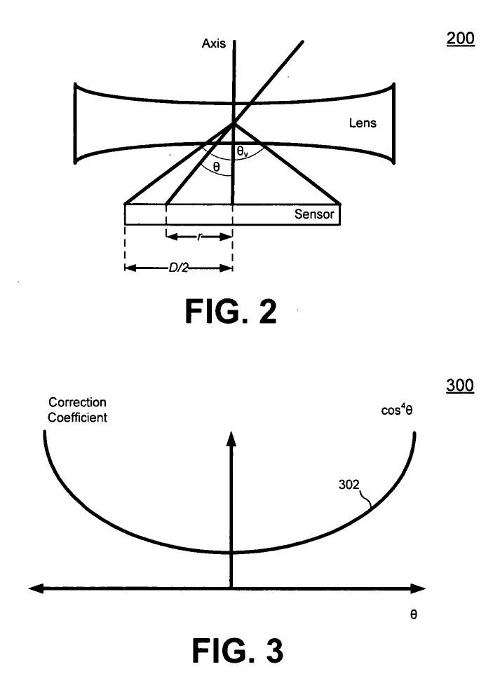

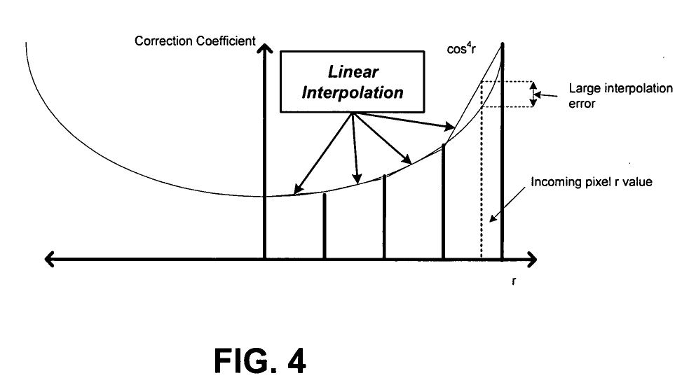

FIGS. 2 and 3 illustrate the above relationships. In particular, FIG. 2 is a diagram 200 illustrating an exemplary relationship between θ and r. FIG. 3 is a graph 300 illustrating an exemplary correction coefficient curve 302, which is a function of θ. As shown in FIG. 3, this curve has a value of cos⁴θ.

As expressed above in Equation (3), determining r involves calculating a square root. Unfortunately, this calculation is computationally expensive in both hardware and software. Therefore, coefficient determination module 108 may advantageously provide techniques that base the determination of compensation coefficients on squared distances (i.e., on r²). Based on Equation (3) above, squared distance is expressed below in Equation (5).
r²(i,j)=(i−i_{c})²+(j−j_{c})² (5)

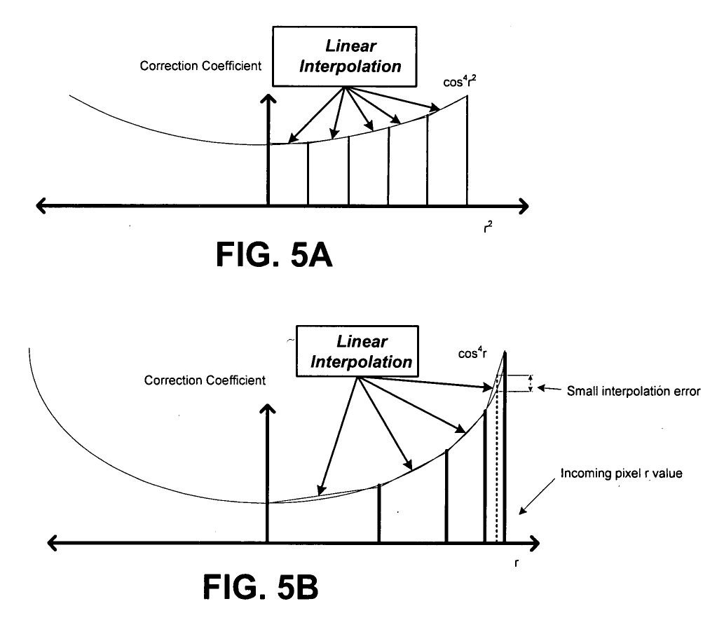

Fall-off correction implementations may employ look-up tables (LUTs) to access correction coefficients for a particular pixel. For instance, FIG. 4 is a graph illustrating the curve of FIG. 3. However, in these drawings, this curve is transformed into a function of r instead of θ.

One fall-off correction approach stores every discrete point of this curve (i.e., a point for each occurring radial distance) in an LUT. This would require the LUT to have a number of entries, N, which also denotes the maximum radial distance.

This can require a large amount of storage. For instance, a Quad Super Extended Graphics Array (QSXGA) image has 2586 by 2048 pixels (constituting approximately 5.2 megapixels) and an aspect ratio of 5:4. Thus, a LUT for QSXGA images would require N to be 1649. This magnitude of LUT entries can be problematic. For example, in a hardware (e.g., integrated circuit) implementation, excessive on-die resources may need to be utilized. Similarly, in software implementations, such a LUT may impose excessive memory allocation requirements.

To reduce on-die resource usage and/or memory requirements, a lower number of LUT entries may be used in combination with an interpolation scheme. More particularly, a correction coefficient curve may be sub-sampled at a constant rate and linear interpolation may be performed between two consecutive sub-sampled points. A drawback of this approach is that substantial interpolation inaccuracies may occur in regions of the curve having a high gradient. For instance, FIG. 4 shows the coefficient curve's gradient increasing with r. Thus, interpolation inaccuracies will similarly increase with r.

Coefficient determination module 108 may reduce such interpolation error by increasing the sampling frequency as the gradient increases. This may involve transforming the coefficient curve so that it is a function of r².

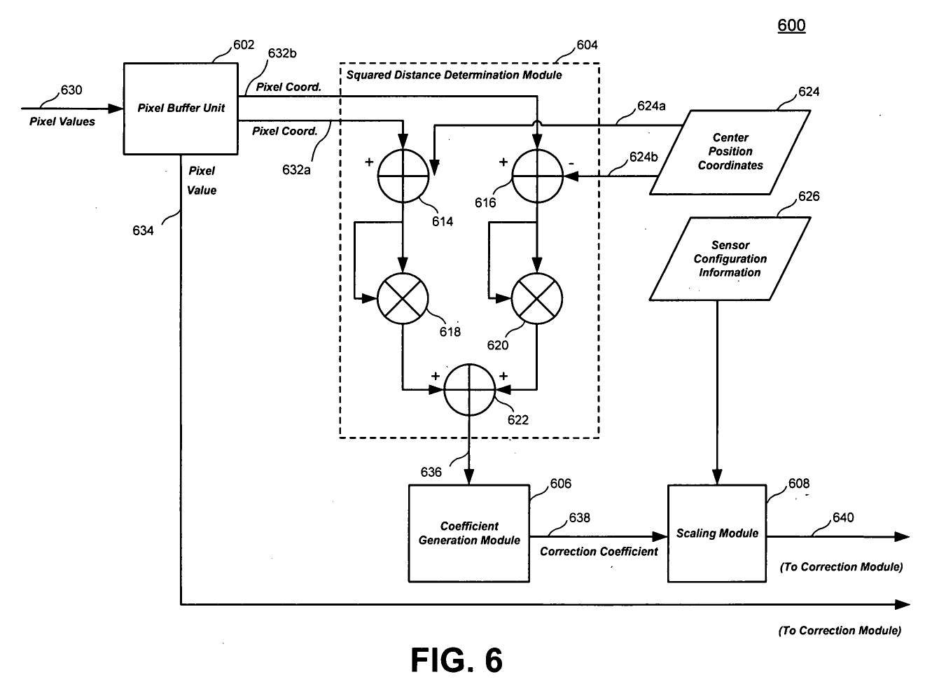

FIG. 5A is a graph illustrating the coefficient curve of FIG. 4 as a function of r². Also, FIG. 5A shows this curve being subsampled at a constant rate (i.e., at constant r² intervals). In addition, linear interpolation may be performed between two consecutive sub-sampled points

Although linear sampling is applied to the curve of FIG. 5A, the curve's gradient doesn't increase as rapidly as the curve in FIG. 4 does. This is because linear sampling in r² space has the effect of being a non-linear sampling in r space. More particularly, linear sampling in r² space has the effect of a sampling rate in r space that increases as r increases.

This feature is illustrated through a comparison of FIGS. 5A and 5B. As described above, FIG. 5A is a graph illustrating the coefficient curve as a function of r². In addition, FIG. 5A shows sampling at equal increments of r². This curve and sampling scheme are translated in FIG. 5B as a function of r. These graphs show that linear interpolation in r² space between successive samples provides a better approximation (less interpolation error) of the coefficient curve.

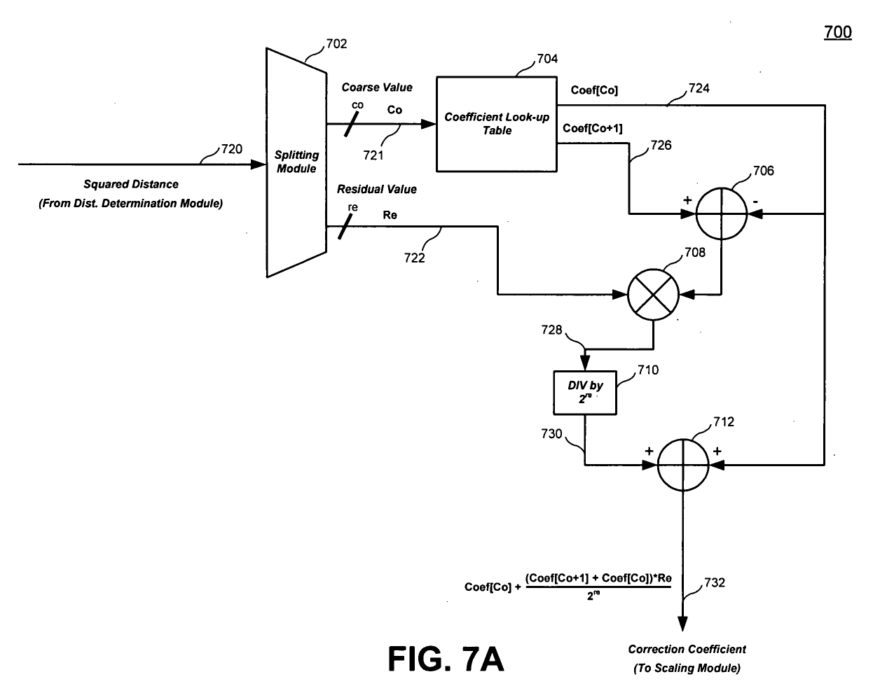

FIG. 6 shows an exemplary implementation embodiment 600 that may be included within coefficient determination module 108. As shown in FIG. 6, this implementation may include various elements. However, the embodiments are not limited to these elements. For instance, embodiments may include greater or fewer elements, as well as other couplings between elements. In particular, FIG. 6 shows that implementation 600 may include a pixel buffer unit 602, a squared distance determination module 604, a coefficient generation module 606, and a scaling module 608. These elements may be implemented in hardware, software, or in any combination thereof.

Pixel buffer unit 602 receives a plurality of pixel values 630 that may correspond to an image, field, or frame. These pixel values may be received from a pixel source, such as image sensor 104. Accordingly, pixel values 630 may be received in a signal stream, such as signal stream 122. Upon receipt, pixel buffer unit 602 stores these values for fall-off correction processing. Accordingly, pixel buffer unit 602 may include a storage medium, such as memory. Examples of storage media are provided below.

Pixel buffer unit 602 may output the pixel values along with their corresponding positions. For instance, FIG. 6 shows pixel buffer unit 602 outputting a pixel value 634 and its corresponding coordinates 632a and 632b. These coordinates are sent to squared distance determination module 604, which determines a squared distance of the corresponding pixel from a center position of its originating image sensor (e.g., image sensor 104).

As described above, squared distance determination module 604 determines squared distances between pixels and an image sensor center position. FIG. 6 shows that this determination is made from pixel coordinates 632a and 632b, as well as center position coordinates 624a and 624b.

Pixel coordinates 632a and 632b are received from pixel buffer unit 602. Center coordinates 624a and 624b may be stored by implementation 600, for example, in memory. Such coordinate information may be predetermined. Alternatively, such coordinate information may be received from an image sensor. For example, pixel and center coordinates may be received from image sensor 104 in sensor information 124. However, the embodiments are not limited in this context.

FIG. 6 shows that squared distance determination module 604 may include combining nodes 614, 616, and 622. In addition, squared distance determination module 604 may include mixing nodes 618 and 620. Combining nodes 614 and 616 calculate differences between pixel coordinates and center coordinates. More particularly, combining node 614 calculates a difference between pixel coordinate 632a and center coordinate 624a. Similarly, combining node 616 calculates a difference between pixel coordinate 632b and center coordinate 624b. FIG. 6 shows that these differences are then squared by mixing nodes 618 and 620. The squared differences are then summed at combining node 622. This produces a squared distance value 636, which is sent to coefficient generation module 606.

Upon receipt of squared distance value 636, coefficient generation module 606 generates or determines a fall-off correction coefficient for the pixel value 634. As described above, this may involve one or more stored coefficient values as well as interpolation techniques. Accordingly, FIG. 6 shows module 606 sending a correction coefficient 638 to scaling module 608.

Scaling module 608 receives correction coefficient 638 and may scale it based on sensor configuration information 626. This information may include, for example, a distance, such as an effective focal length, between an optics assembly and a sensor plane of an image sensor. Configuration information 626 may be received in various ways. For instance, with reference to FIG. 1, this information may be received from image sensor 104 in sensor information 124. However, the embodiments are not limited in this context.

When scaling according to effective focal length, scaling module 608 may increase fall-off coefficient 638 when the effective focal length increases. Alternatively, scaling module 608 may decrease fall-off coefficient 638 when the effective focal length decreases. Such scaling may be performed through the use of a multiplicative scaling coefficient. Such coefficients may be selected from a focal length to scaling coefficient mapping. However, the embodiments are not limited in this context. In fact, scaling does not need to be performed.

As shown in FIG. 6, implementation 600 sends a potentially scaled correction coefficient 640 and pixel value 634 to a correction module for fall-off correction. At the correction module, pixel value 634 and coefficient 640 may be multiplied to produce a corrected pixel value. With reference to FIG. 1, this correction module may be fall-off correction module 110. However, the embodiments are not limited in this context.

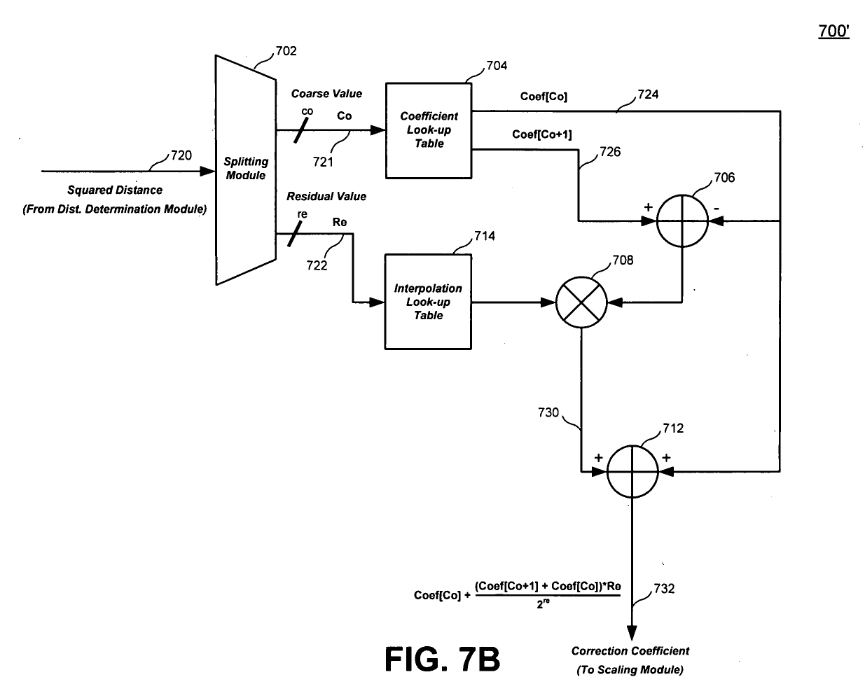

Coefficient generation module 606 may be implemented in various ways. As such, exemplary implementations are shown in FIGS. 7A and 7B. The embodiments, however, are not limited to the implementations shown in these drawings. For instance, embodiments may include greater or fewer elements, as well as other couplings between elements.

FIG. 7A shows an implementation 700 that may be included in coefficient generation module 606. This implementation may include a splitting module 702, a coefficient look-up table 704, a combining node 706, a mixing node 708, a division node 710, and a combining node 712.

As shown in FIG. 7A, splitting module 702 may receive a squared distance 720. Squared distance 720 may be received from various sources, such as squared distance determination module 604. Upon receipt, splitting module 702 separates this squared distance into a coarse value 721 (also shown as Co) and a residual value 722 (also shown as Re). With reference to binary implementations, coarse value 721 may be a certain number, co, of most significant bits from squared distance 720, while residual value 722 may be the remaining number of least significant bits, re.

Coarse value 721 is used for table look-up, while residual value 722 is used for interpolation. Accordingly, FIG. 7A shows coarse value 721 being used to address coefficient look-up table (LUT) 704. As a result of this addressing, coefficient LUT 704 outputs a first coefficient 724 and a second coefficient 726. First coefficient 724 (also shown as Coef[Co]) directly corresponds to coarse value 721. However, second coefficient 726 (also shown as Coef[Co+1]) corresponds to the next higher coarse value.

FIG. 7A shows that a difference between coefficients 724 and 726 is calculated at combining node 706. In turn, this difference is then multiplied with residual value 722 at mixing node 708. This produces an intermediate result 728, which is divided by the possible range of residual value 722 at dividing module 710. In binary implementations, this possible range is 2^{re}. This division produces an interpolation component 730, which is added to first coefficient at combining node 712.

Thus, combining node 712 produces a correction coefficient 732, which is expressed below in Equation (6).

$$Coef [ Co ] + \frac{( Coef [ Co + 1 ] + Coef [ Co ] ) * Re}{{2}^{re}} \qquad ( 6 )$$

FIG. 7B shows an implementation 700′ that is similar to implementation 300 of FIG. 3A. However, in FIG. 7B, division node 710 is replaced by an interpolation LUT 714. This LUT provides interpolation components for each possible residual value 722. As described herein, techniques, such as the ones of FIGS. 7A and 7B advantageously reduce error, simplify lookup, and increase computational efficiency.

In addition, such techniques reduce power consumption. This advantageously increases battery life for devices, such as cameras, portable phones, and personal digital assistants (PDAs). Also, for hardware implementations, complexity and required area are reduced.

More particularly, the techniques described herein may provide advantages over grid-based implementations in which compensation coefficients for grid points are stored in a LUT. In such approaches, correction factors for individual points may be calculated using bi-cubic or bi-linear interpolation algorithms. Such algorithms require further set(s) of LUTs and much larger hardware and/or control logic. Thus, such grid-based implementations involve multiple LUTs and larger hardware and/or control logic to arrive at final correction coefficients.

In contrast, the techniques described herein smaller LUT(s) and less interpolation hardware/control logic. This is because a linear interpolation, as compared to bi-cubic or bi-linear interpolation. Moreover, the techniques described herein may eliminate the use of costly hardware and/or control logic to evaluate square roots for obtaining the actual radial distance from the center location. Further, LUT sizes may be reduced by using coarse values. However, accuracy is maintained through interpolation that employs the residual values.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. Also, the flows may include additional operations as well as omit certain described operations. In addition, the given logic flow may be implemented by a hardware element, a software element executed by a processor, or any combination thereof. The embodiments are not limited in this context.

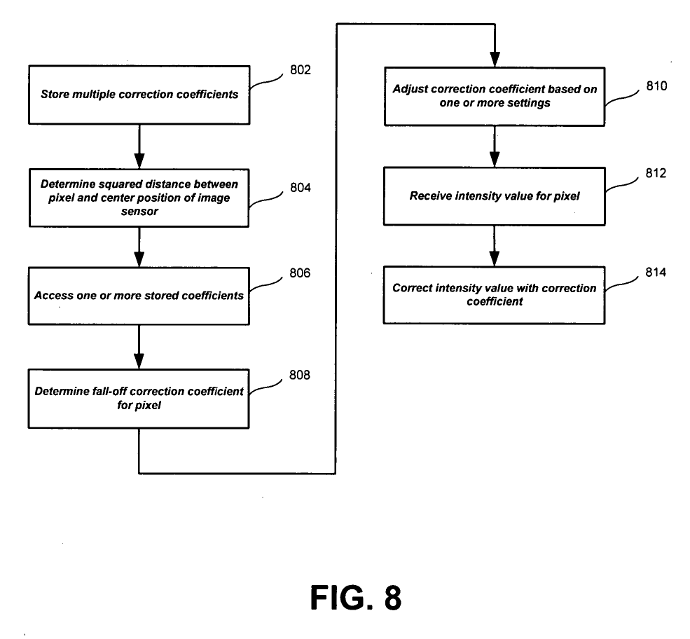

FIG. 8 illustrates one embodiment of a logic flow. This flow may be representative of the operations executed by one or more embodiments described herein. As shown in FIG. 8, this flow includes a block 802. At this block, a plurality of fall-off correction coefficient values may be stored. Each of these coefficients corresponds a squared distance from a center position of an image sensor. Thus, coefficients for multiple squared distances may be stored. These multiple squared distances may be separated at substantially equal intervals. As described above, this feature may advantageously reduce fall-off correction errors.

At a block 804, a squared distance is determined between a pixel of the image sensor and the center position of the image sensor. Based on the determined squared distance, one or more of the stored coefficient values are accessed at a block 806. This may comprise accessing two stored coefficient values. These two values may correspond to adjacent squared distances.

These accessed coefficient value(s) may be used at a block 808 to determine a fall-off correction coefficient for the pixel. When two stored coefficient values corresponding to adjacent squared distances are accessed at block 806, this determination may comprise interpolating between the two coefficient values.

At a block 810, the determined fall-off correction coefficient may be adjusted or scaled. This may be based on various settings, such an optical focal length associated with the image sensor.

At a block 812, an intensity value corresponding to the pixel is received. This intensity value is corrected at a block 814 by multiplying it with the determined fall-off correction coefficient.

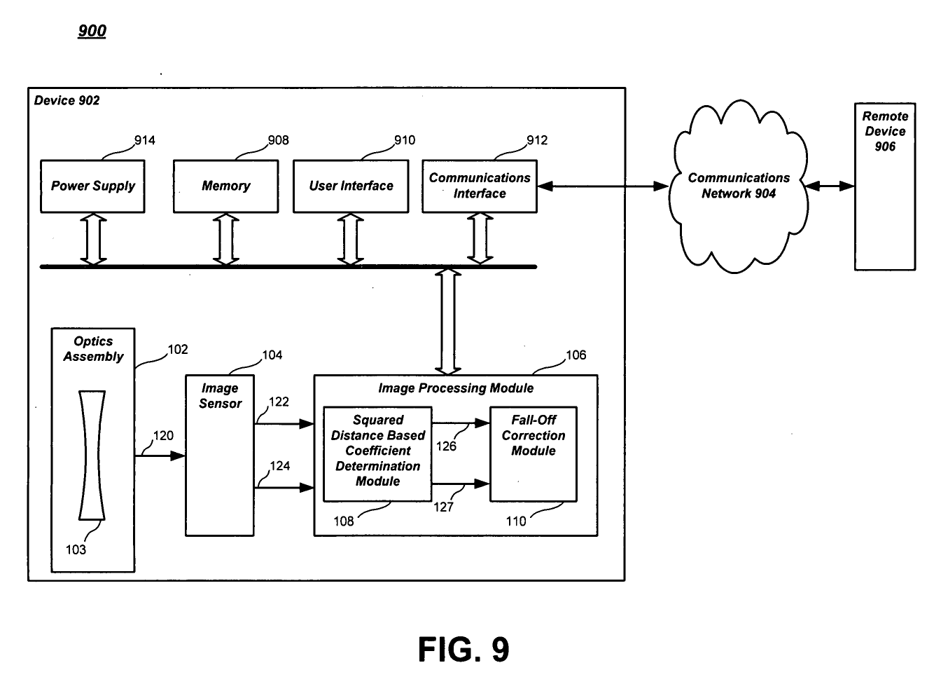

FIG. 9 illustrates an embodiment of a system 900. This system may be representative of a system or architecture suitable for use with one or more embodiments described herein, such as apparatus 100, implementations 600, 700, and 700′, as well as with logic flow 800, and so forth. Accordingly, system 900 may capture images and perform fall-off compression according to techniques, such as the ones described herein. In addition, system 900 may display images and store corresponding data. Moreover, system 900 may exchange image data with remote devices.

As shown in FIG. 9, system 900 may include a device 902, a communications network 904, and one or more remote devices 906. FIG. 9 shows that device 902 may include the elements of FIG. 1. In addition, device 902 may include a memory 908, a user interface 910, a communications interface 912, and a power supply 914. These elements may be coupled according to various techniques. One such technique involves employment of one or more bus interfaces.

Memory 908 may store information in the form of data. For instance, memory 908 may contain LUTs, such as LUT 704 and/or LUT 714. Also, memory 908 may store image data, such as pixels and position information managed by pixel buffer unit 602 and operational data. Examples of operational data include center position coordinates and sensor configuration information (e.g., effective focal length). Memory 908 may also store one or more images (with or without fall-off correction). However, the embodiments are not limited in this context.

Alternatively or additionally, memory 908 may store control logic, instructions, and/or software components. These software components include instructions that can be executed by a processor. Such instructions may provide functionality of one or more elements in system 900.

Memory 908 may be implemented using any machine-readable or computer-readable media capable of storing data, including both volatile and non-volatile memory. For example, memory 908 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 908 may be included in other elements of system 900. For instance, some or all of memory 908 may be included on a same integrated circuit or chip with as image processing module 106. Alternatively some portion or all of memory 908 may be disposed on an integrated circuit or other medium, for example a hard disk drive, which is external. The embodiments are not limited in this context.

User interface 910 facilitates user interaction with device 902. This interaction may involve the input of information from a user and/or the output of information to a user. Accordingly, user interface 910 may include one or more devices, such as a keypad, a touch screen, a microphone, and/or an audio speaker. In addition, user interface 910 may include a display to output information and/or render images/video processed by device 902. Exemplary displays include liquid crystal displays (LCDs), plasma displays, and video displays.

Communications interface 912 provides for the exchange of information with other devices across communications media, such as network. This information may include image and/or video signals transmitted by device 902. Also, this information may include transmissions received from remote devices, such as requests for image/video transmissions and commands directing the operation of device 902.

Communications interface 912 may provide for wireless or wired communications. For wireless communications, communications interface 912 may include components, such as a transceiver, an antenna, and control logic to perform operations according to one or more communications protocols. Thus, communications interface 912 may communicate across wireless networks according to various protocols. For example, device 902 and device(s) 906 may operate in accordance with various wireless local area network (WLAN) protocols, such as the IEEE 802.11 series of protocols, including the IEEE 802.11a, 802.11b, 802.11e, 802.11g, 802.11n, and so forth. In another example, these devices may operate in accordance with various wireless metropolitan area network (WMAN) mobile broadband wireless access (MBWA) protocols, such as a protocol from the IEEE 802.16 or 802.20 series of protocols. In another example, these devices may operate in accordance with various wireless personal area networks (WPAN). Such networks include, for example, IEEE 802.16e, Bluetooth, and the like. Also, these devices may operate according to Worldwide Interoperability for Microwave Access (WiMax) protocols, such as ones specified by IEEE 802.16.

Also, these devices may employ wireless cellular protocols in accordance with one or more standards. These cellular standards may comprise, for example, Code Division Multiple Access (CDMA), CDMA 2000, Wideband Code-Division Multiple Access (W-CDMA), Enhanced General Packet Radio Service (GPRS), among other standards. The embodiments, however, are not limited in this context.

For wired communications, communications interface 912 may include components, such as a transceiver and control logic to perform operations according to one or more communications protocols. Examples of such communications protocols include Ethernet (e.g., IEEE 802.3) protocols, integrated services digital network (ISDN) protocols, public switched telephone network (PSTN) protocols, and various cable protocols.

In addition, communications interface 912 may include input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Power supply 914 provides operational power to elements of device 902. Accordingly, power supply 914 may include an interface to an external power source, such as an alternating current (AC) source. Additionally or alternatively, power supply 914 may include a battery. Such a battery may be removable and/or rechargeable. However, the embodiments are not limited to this example.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a coefficient determination module to determine a fall-off correction coefficient for a pixel of an image sensor, the fall-off correction coefficient based on one or more of a plurality of stored coefficient values, wherein the one or more stored coefficient values correspond to a squared distance between the pixel and a center position of the image sensor; and
a fall-off correction module to correct the pixel based on an intensity value of the pixel and the fall-off correction coefficient.

2. The apparatus of claim 1, wherein the coefficient determination module comprises a squared distance determination module to determine the squared distance between the pixel and the center position of the image sensor.

3. The apparatus of claim 1, further comprising:
a memory to store the plurality of stored coefficient values in a coefficient look-up table (LUT), the LUT having addresses for the plurality of coefficient values, wherein the addresses are based on corresponding squared distances from the center position of the image sensor.

4. The apparatus of claim 3, wherein the squared distances corresponding to the addresses are separated at substantially equal intervals.

5. The apparatus of claim 3, wherein the memory further comprises an interpolation LUT to store interpolation factors between consecutive entries in the coefficient LUT.

6. The apparatus of claim 1, wherein the coefficient determination module comprises a scaling module to adjust the fall-off correction coefficient based on an optical focal length associated with the image sensor.

7. The apparatus of claim 1, further comprising the image sensor.

8. The apparatus of claim 1, further comprising a display to display images corresponding to pixel values provided by the image sensor.

9. The apparatus of claim 1, further comprising a communications interface to send image signals to a remote device, the image signals corresponding to pixel values provided by image sensor.

10. The apparatus of claim 1, further comprising a memory to store the plurality of stored coefficient values.

11. An apparatus, comprising:
a coefficient determination module to determine a fall-off correction coefficient for a pixel of an image sensor, the fall-off correction coefficient based on one or more of a plurality of stored coefficient values, wherein the one or more stored coefficient values correspond to a squared distance between the pixel and a center position of the image sensor; and
a fall-off correction module to correct the pixel based on an intensity value of the pixel and the fall-off correction coefficient; and
a scaling module to adjust the fall-off correction coefficient based on an optical focal length associated with the image sensor;
wherein the plurality of stored coefficient values corresponds to a plurality of squared distances separated at substantially equal intervals.

12. A method, comprising:
storing a plurality of fall-off correction coefficient values, each coefficient value corresponding to one of a plurality of squared distances from a center position of an image sensor;
determining a squared distance between a pixel of the image sensor and the center position of the image sensor;
accessing one or more of the stored coefficient values based on the determined squared distance; and
determining a fall-off correction coefficient for the pixel based on the one or more accessed fall-off correction coefficient values.

13. The method of claim 12, further comprising:
receiving an intensity value corresponding to the pixel; and
multiplying the intensity value with the determined fall-off correction coefficient.

14. The method of claim 12, wherein the plurality of squared distances are separated at substantially equal intervals.

15. The method of claim 12:
wherein accessing the one or more correction coefficient values comprises accessing first and second stored coefficient values; and
wherein determining the fall-off correction coefficient comprises interpolating between the first and second stored coefficient values.

16. The method of claim 12, further comprising:
adjusting the determined fall-off correction coefficient based on an optical focal length associated with the image sensor.

17. An article comprising a machine-readable storage medium containing instructions that if executed enable a system to:
store a plurality of fall-off correction coefficient values, each coefficient value corresponding to one of a plurality of squared distances from a center position of an image sensor;
determine a squared distance between a pixel of the image sensor and the center position of the image sensor;
access one or more of the stored coefficient values based on the determined squared distance; and
determine a fall-off correction coefficient for the pixel based on the one or more accessed fall-off correction coefficient values.

18. The article of claim 17, further comprising instructions that if executed enable the system to store the plurality of coefficient values in a coefficient look-up table (LUT), the LUT having addresses for the plurality of coefficients, wherein the addresses are based on corresponding squared distances from the center position of the image sensor that are separated at substantially equal intervals.

19. The article of claim 17, further comprising instructions that if executed enable the system to adjust the determined fall-off correction coefficient based on an optical focal length associated with the image sensor.

20. The article of claim 17, further comprising instructions that if executed enable the system to determine the fall-off correction coefficient for the pixel based on an interpolation between first and second stored coefficient values.
